(19) United States
(12) Patent Application Publication
(10) Pub. No.: US 2025/0101291 A1
(43) Pub. Date: Mar. 27, 2025

(54) INHIBITOR COMPOSITIONS COMPRISING SCALE AND CORROSION INHIBITORS

(71) Applicant: ChampionX LLC, Sugar Land, TX (US)

(72) Inventors: Subhasis De, Sugar Land, TX (US); Mi Thuy Bui, Houston, TX (US); Julian M. Gallardo, III, Sugar Land, TX (US)

(21) Appl. No.: 18/891,574

(22) Filed: Sep. 20, 2024

Related U.S. Application Data
(60) Provisional application No. 63/584,269, filed on Sep. 21, 2023.

(51) Int. Cl. C09K 8/54; C09K 8/528

(52) U.S. Cl. CPC C09K 8/54; C09K 8/528; C09K 2208/32

(57) ABSTRACT

The present disclosure describes inhibitor compositions comprises a corrosion inhibitor, a scale inhibitor, a stabilizing corrosion inhibitor and a polar solvent. These inhibitor compositions can be used in the oil and gas industry and are formulated to provide a stable inhibitor composition that has stability in extreme conditions, such as high temperature, high pressure, or low pressure.

### FIELD

The present disclosure describes inhibitor compositions comprising a corrosion inhibitor, a scale inhibitor, a stabilizing corrosion inhibitor, and a polar solvent. These inhibitor compositions can be used in the oil and gas industry and are formulated to provide a stable inhibitor composition that has stability in extreme conditions, such as high temperature, low temperature, high pressure and negative pressure.

### BACKGROUND

Oilfield fluids are complex mixtures of aliphatic hydrocarbons, aromatics, compound containing heteroatoms, anionic and cationic salts, acids, water, gas, and myriad other components. With this complex mixture comes problems with deposition of various components in unwanted portions of the extraction process. For example, deposition of scale, salts, paraffins, asphaltene, bacteria, and the like can occur during the extraction process.

This deposition process of various components can lead to restriction or plugging in production piping or the flow path of the mixture in the reservoir. Various treatments to remedy this plugging or restriction of flow paths has been performed including both mechanical and chemical treatments with varying success.

One treatment method is to provide an inhibitor composition that provides inhibition of more than one deposit, for example, an inhibitor composition that comprises a corrosion inhibitor and a scale inhibitor. Some inhibitor compositions comprising a corrosion inhibitor and a scale inhibitor are not stable and cause problems such as scale deposition or precipitation of components when deployed into an oil well or reservoir.

Thus, a need exists for effective, cost effective, and stable inhibitor compositions for treatment of oilfield fluids and for a more effective and efficient method for treating oilfield fluids with the inhibitor compositions.

### SUMMARY

The current disclosure is directed to inhibitor compositions comprising from about 1 wt. % to about 80 wt. % of a polar solvent; a corrosion inhibitor comprising an amine-fatty acid condensate compound, a quaternary ammonium compound, a carboxyl alkene-alkanoic acid compound, an organic sulfur compound, a phosphate ester, or a combination thereof, a scale inhibitor comprising a polymer derived from a dicarboxylic acid and an allyl sulfonate, a polycarboxylate, an amine phosphonate, a polyamino polyether alkylene phosphonic acid, polyalkylene polyamine polycarboxylic acid, or a combination thereof, and a stabilizing corrosion inhibitor comprising an aromatic amine, an alkylamine, an alkyl hydroxyl amine, or a combination thereof.

Also disclosed are methods of inhibiting corrosion and/or scale deposition comprising contacting the inhibitor compositions disclosed herein with a hydrocarbon fluid in a subterranean hydrocarbon-containing reservoir.

Other objects and features will be in part apparent and in part pointed out hereinafter.

### DESCRIPTION OF THE DRAWINGS

FIG. 1 shows a graph of the percent inhibition of scale in the static bottle test (SBT) for various dosages of the agents at 2 hours, 4 hours, and 24 hours.

FIG. 2 shows a graph of the percent inhibition of scale in the static barite bottle test for various dosages of the agents at 2 hours and 4 hours.

FIG. 3 shows a graph of the differential pressure in the Dynamic Scale Loop (DSL) test used to determine the scale inhibiting properties of Products 96A and 63B.

Corresponding reference characters indicate corresponding parts throughout the drawings.

### DESCRIPTION OF THE PREFERRED EMBODIMENTS

Among the objects of this disclosure are compositions comprising Corrosion Inhibitors (CIs) and/or mineral Scale Inhibitors (SIs) for application in the oil and gas production industry. Products are formulated with traditional corrosion inhibitors, and can also include commonly used scale inhibitor components. Various additives are used to maintain a stable formulation of multifunctional groups without compromising the required corrosion and/or scale inhibitor performance. The formulations can contain different film forming corrosion inhibitors and organic passivators. Organic passivators with oxygen scavenging properties are advantageous to control the overall pH of the composition and to reduce the potential corrosion resulting from acidic scale inhibitors. The components of the composition are chosen to maximize corrosion and scale inhibition performance and composition stability by controlling the pH of the composition

Additional additives having surfactant properties are used to stabilize the formulations in addition to the presence of a polar solvent. Particular solvent ratios can be advantageous to meet application requirements for particular environments.

The compositions disclosed herein have many advantageous properties including that they are effective against CO₂ and H₂S corrosion in high temperature and high pressure environments, show increased CI film persistence in a high shear environment, inhibit calcite and barite formation, have a low tendency to form an emulsion, are stable in a high total dissolved solids (TDS) brine environment, provide a low viscosity composition suitable for down-hole injection, are compatible with Low Alloy Steels (LAS) such as F-22 and C-1018 carbon steels, have high vacuum tolerance that is suitable for umbilical and gas lift applications, suitable for capillary injection, have desired low and high thermal stability depending on the application requirement, provide lower operating and maintenance expenses by reducing the number of injection pumps, and save storage space with fewer tanks specially for offshore platforms.

Prior to this work, compositions comprising a CI and SI were limited to specific scale inhibitors combined with select corrosion inhibitor chemistries. A wider range of both scale inhibitors and corrosion inhibitors are used advantageously in the disclosed inhibitor compositions. In addition, inhibitor compositions can be designed to meet application specific requirements. Moreover, the inhibitor compositions provide advantageous performance in both scale and corrosion applications. For example, a polycarboxylate-containing scale inhibitor reduces the chemical corrosivity of the inhibitor composition towards low alloy metallurgies. Additionally, surfactant-containing corrosion inhibitors help reduce scale formation by dispersing the scaling ions. These inhibitor compositions also do not require additional bases to neutralize acidic scale inhibitors. Various additives including corrosion inhibitors are chosen in such a way to neutralize the acidic scale inhibitors in situ in a one pot blend with improved long-term stability of the composition. Multiple scale inhibitors such as phosphonates and sulfonates can also be formulated together without chemical compatibility or stability concerns and address higher scale-forming environments.

This disclosure describes inhibitor compositions comprising from about 1 wt. % to about 80 wt. % of a polar solvent; a corrosion inhibitor comprising an amine-fatty acid condensate compound, a quaternary ammonium compound, a carboxyl alkene-alkanoic acid compound, an organic sulfur compound, a phosphate ester, or a combination thereof, a scale inhibitor comprising a polymer derived from a dicarboxylic acid and an allyl sulfonate, a polycarboxylate, an amine phosphonate, a polyamino polyether alkylene phosphonic acid, polyalkylene polyamine polycarboxylic acid, or a combination thereof, and a stabilizing corrosion inhibitor comprising an aromatic amine, an alkylamine, an alkyl hydroxyl amine, or a combination thereof.

The inhibitor compositions can have the concentration of the polar solvent be based on the total amount of the polar solvent, the corrosion inhibitor, the scale inhibitor, and the stabilizing corrosion inhibitor.

This disclosure additionally describes inhibitor compositions comprising from about 1 wt. % to about 80 wt. % of a polar solvent; a corrosion inhibitor comprising an amine-fatty acid condensate compound, a quaternary ammonium compound, a carboxyl alkene-alkanoic acid compound, an organic sulfur compound, a phosphate ester, or a combination thereof, a scale inhibitor comprising a polymer derived from a dicarboxylic acid and an allyl sulfonate, a polycarboxylate, an amine phosphonate, a polyamino polyether alkylene phosphonic acid, polyalkylene polyamine polycarboxylic acid, or a combination thereof, and a stabilizing corrosion inhibitor comprising an aromatic amine, an alkylamine, an alkyl hydroxyl amine, or a combination thereof; wherein the concentration of the polar solvent is based on the total amount of the polar solvent, the corrosion inhibitor, the scale inhibitor and the stabilizing corrosion inhibitor.

The inhibitor compositions described above can have a concentration of the polar solvent from about 1 wt. % to about 80 wt. %, from about 1 wt. % to about 70 wt. %, from about 5 wt. % to about 80 wt. %, from about 5 wt. % to about 70 wt. %, from about 10 wt. % to about 80 wt. %, from about 10 wt. % to about 70 wt. %, from about 15 wt. % to about 80 wt. %, from about 15 wt. % to about 70 wt. %, from about 20 wt. % to about 80 wt. %, from about 20 wt. % to about 70 wt. %, from about 25 wt. % to about 80 wt. %, from about 25 wt. % to about 70 wt. %, from about 30 wt. % to about 80 wt. %, from about 30 wt. % to about 70 wt. %, from about 35 wt. % to about 80 wt. %, from about 35 wt. % to about 70 wt. %, from about 35 wt. % to about 45 wt. %, from about 35 wt. % to about 43 wt. %, from about 38 wt. % to about 45 wt. %, or from about 38 wt. % to about 43 wt. %, based on the total amount of the polar solvent, the corrosion inhibitor, the scale inhibitor, and the stabilizing corrosion inhibitor.

The inhibitor compositions can have the polar solvent be present in the inhibitor composition at a concentration of from about 10 wt. % to about 30 wt. %, or from about 14 wt. % to about 24 wt. %, based on the total amount of the polar solvent, the corrosion inhibitor, the scale inhibitor, the stabilizing corrosion inhibitor, and the stabilizing agent.

The inhibitor compositions described herein can further comprise a stabilizing agent.

The inhibitor compositions can have the stabilizing agent comprise a surfactant.

Additionally, the inhibitor compositions described herein can also have the surfactant comprise a phosphate ester, an oxyalkylated compound, a dialkyl sulfosuccinate, an organic sulfonic acid, or a combination thereof. In particular, the surfactant can comprise ethoxylated nonylphenol, alkylphenyl ethoxylate, polyoxyethylene nonylphenyl ether, di octyl sodium sulfosuccinate, or a combination thereof.

The inhibitor compositions can have the corrosion inhibitor comprise a film forming corrosion inhibitor selected from an amine-fatty acid condensate, a quaternary ammonium compound, a carboxyl alkene-alkanoic acid compound, or a combination thereof.

The inhibitor compositions can have the film forming corrosion inhibitor be present in the inhibitor composition in a concentration from about 1 wt. % to about 60 wt. %, from about 1 wt. % to about 50 wt. %, from about 1 wt. % to about 45 wt. %, from about 1 wt. % to about 40 wt. %, from about 1 wt. % to about 35 wt. %, from about 3 wt. % to about 60 wt. %, from about 3 wt. % to about 50 wt. %, from about 3 wt. % to about 45 wt. %, from about 3 wt. % to about 40 wt. %, from about 3 wt. % to about 35 wt. %, from about 5 wt. % to about 60 wt. %, from about 5 wt. % to about 50 wt. %, from about 5 wt. % to about 45 wt. %, from about 5 wt. % to about 40 wt. %, from about 5 wt. % to about 35 wt. %, from about 7 wt. % to about 60 wt. %, from about 7 wt. % to about 50 wt. %, from about 7 wt. % to about 45 wt. %, from about 7 wt. % to about 40 wt. %, from about 7 wt. % to about 35 wt. %, from about 25 wt. % to about 35 wt. %, from about 27 wt. % to about 35 wt. %, or from about 28 wt. % to about 35 wt. %, based on the total amount of the polar solvent, the corrosion inhibitor, the scale inhibitor, and the stabilizing corrosion inhibitor, and the stabilizing agent.

The inhibitor compositions described herein having the film forming corrosion inhibitor is present in the inhibitor composition in a concentration from about 8 wt. % to about 35 wt. %, based on the total amount of the polar solvent, the corrosion inhibitor, the scale inhibitor, the stabilizing corrosion inhibitor, and the stabilizing agent.

Further, the inhibitor composition described herein can have the stabilizing corrosion inhibitor comprise an aromatic amine, an alkylamine, a cyclic amine, an alkyl hydroxyl amine, or a combination thereof.

Preferably, the inhibitor composition has the stabilizing corrosion inhibitor comprise morpholine, triethanolamine, diethylhydroxylamine, or a combination thereof.

The inhibitor compositions can have the stabilizing corrosion inhibitor be present in the inhibitor composition in a concentration from about 0.1 wt. % to about 15 wt. %, from about 0.1 wt. % to about 14 wt. %, from about 0.1 wt. % to about 13 wt. %, from about 0.5 wt. % to about 15 wt. %, from about 0.5 wt. % to about 14 wt. %, from about 0.5 wt. % to about 13 wt. %, from about 1 wt. % to about 15 wt. %, from about 1 wt. % to about 14 wt. %, from about 1 wt. % to about 13 wt. %, from about 1.5 wt. % to about 15 wt. %, from about 1.5 wt. % to about 14 wt. %, from about 1.5 wt. % to about 13 wt. %, from about 2 wt. % to about 15 wt. %, from about 2 wt. % to about 14 wt. %, from about 2 wt. % to about 13 wt. %, from about 2 wt. % to about 10 wt. %, from about 2 wt. % to about 9 wt. %, from about 2 wt. % to about 8 wt. %, from about 2 wt. % to about 7 wt. %, or from about 2 wt. % to about 6 wt. %, based on the total amount of the polar solvent, the corrosion inhibitor, the scale inhibitor, the stabilizing corrosion inhibitor, and the stabilizing agent.

The inhibitor compositions described herein can have the neutralizing corrosion inhibitor is present in the inhibitor composition in a concentration from about 2 wt. % to about 10 wt. %, based on the total amount of the polar solvent, the corrosion inhibitor, the scale inhibitor, the stabilizing corrosion inhibitor, and the stabilizing agent.

Also, the inhibitor compositions can have the stabilizing agents be present in the inhibitor composition in a concentration from about 0.1 wt. % to about 15 wt. %, 0.1 wt. % to about 12 wt. %, 0.1 wt. % to about 10 wt. %, 0.1 wt. % to about 8 wt. %, 0.1 wt. % to about 5 wt. %, from about 1 wt. % to about 15 wt. %, 1 wt. % to about 12 wt. %, 1 wt. % to about 10 wt. %, 1 wt. % to about 8 wt. %, 1 wt. % to about 5 wt. %, from about 2 wt. % to about 15 wt. %, 2 wt. % to about 12 wt. %, 2 wt. % to about 10 wt. %, 2 wt. % to about 8 wt. %, or 2 wt. % to about 5 wt. %, based on the total amount of the polar solvent, the corrosion inhibitor, the scale inhibitor, the stabilizing corrosion inhibitor, and the stabilizing agent.

The inhibitor compositions can have the stabilizing agent be present in the inhibitor composition in a concentration from about 2 wt. % to about 6 wt. %, based on the total amount of the polar solvent, the corrosion inhibitor, the scale inhibitor, the stabilizing corrosion inhibitor, and the stabilizing agent.

The inhibitor compositions described herein can have the scale inhibitor be present in the inhibitor composition in a concentration from about 1 wt. % to about 60 wt. %, from about 1 wt. % to about 50 wt. %, from about 1 wt. % to about 40 wt. %, from about 1 wt. % to about 30 wt. %, from about 1 wt. % to about 25 wt. %, from about 5 wt. % to about 60 wt. %, from about 5 wt. % to about 50 wt. %, from about 5 wt. % to about 40 wt. %, from about 5 wt. % to about 30 wt. %, from about 5 wt. % to about 25 wt. %, from about 10 wt. % to about 60 wt. %, from about 10 wt. % to about 50 wt. %, from about 10 wt. % to about 40 wt. %, from about 10 wt. % to about 30 wt. %, from about 10 wt. % to about 25 wt. %, from about 12 wt. % to about 60 wt. %, from about 12 wt. % to about 50 wt. %, from about 12 wt. % to about 40 wt. %, from about 12 wt. % to about 30 wt. %, from about 12 wt. % to about 25 wt. %, or from about 13 wt. % to about 23 wt. %, based on the total amount of the polar solvent, the corrosion inhibitor, the scale inhibitor, the stabilizing corrosion inhibitor, and the stabilizing agent.

The inhibitor compositions can have the scale inhibitor be present in the inhibitor composition in a concentration from about 3 wt. % to about 30 wt. %, or from about 5 wt. % to about 20 wt. %, based on the total amount of the polar solvent, the corrosion inhibitor, the scale inhibitor, the stabilizing corrosion inhibitor, and the stabilizing agent.

The polar solvent can be protic or aprotic.

The inhibitor compositions can have the polar solvent comprise ethylene glycol, propylene glycol, ethylene glycol monobutyl ether, methanol, ethanol, propanol, isopropanol, water, or a combination thereof.

Preferably, the polar solvent comprises ethylene glycol, methanol, water, or a combination thereof.

The inhibitor compositions can have the polar solvent comprise methanol and the methanol be present in the inhibitor composition at a concentration of from about 5 wt. % to about 20 wt. %, based on the total amount of the polar solvent, the corrosion inhibitor, the scale inhibitor, the stabilizing corrosion inhibitor, and the stabilizing agent.

The inhibitor compositions described herein can have the polar solvent comprise methanol and the methanol be present in the inhibitor composition at a concentration of from about 8 wt. % to about 14 wt. %, based on the total amount of the polar solvent, the corrosion inhibitor, the scale inhibitor, the stabilizing corrosion inhibitor, and the stabilizing agent.

The inhibitor compositions can have the polar solvent comprise water and the water be present in the inhibitor composition at a concentration of from about 5 wt. % to about 40 wt. %, based on the total amount of the polar solvent, the corrosion inhibitor, the scale inhibitor, the stabilizing corrosion inhibitor, and the stabilizing agent.

The inhibitor compositions can have the polar solvent comprise water and the water be present in the inhibitor composition at a concentration of from about 9 wt. % to about 32 wt. %, based on the total amount of the polar solvent, the corrosion inhibitor, the scale inhibitor, the stabilizing corrosion inhibitor, and the stabilizing agent.

The inhibitor compositions can have the corrosion inhibitor comprise the amine-fatty acid condensate compound and the amine-fatty acid condensate compound be present in the inhibitor composition at a concentration of from about 1 wt. % to about 20 wt. %, based on the total amount of the polar solvent, the corrosion inhibitor, the scale inhibitor, the stabilizing corrosion inhibitor, and the stabilizing agent.

The inhibitor compositions can have the corrosion inhibitor comprise the amine-fatty acid condensate compound and the amine-fatty acid condensate compound be present in the inhibitor composition at a concentration of from about 4 wt. % to about 15 wt. %, based on the total amount of the polar solvent, the corrosion inhibitor, the scale inhibitor, the stabilizing corrosion inhibitor, and the stabilizing agent.

The inhibitor compositions can have the corrosion inhibitor comprise the quaternary ammonium compound (e.g., N-benzyl alkyl pyridinium halide) and the quaternary ammonium compound (e.g., benzalkonium halide) be present in the inhibitor composition at a concentration of from about 1 wt. % to about 25 wt. %, based on the total amount of the polar solvent, the corrosion inhibitor, the scale inhibitor, the stabilizing corrosion inhibitor, and the stabilizing agent.

The inhibitor compositions can have the corrosion inhibitor comprise the quaternary ammonium compound (e.g., N-benzyl alkyl pyridinium halide) and the quaternary ammonium compound (e.g., benzalkonium halide) be present in the inhibitor composition at a concentration of from about 2 wt. % to about 20 wt. %, based on the total amount of the polar solvent, the corrosion inhibitor, the scale inhibitor, the stabilizing corrosion inhibitor, and the stabilizing agent.

The inhibitor compositions described herein can have the corrosion inhibitor comprise the carboxyl alkene-alkanoic acid compound and the carboxyl alkene-alkanoic acid compound be present in the inhibitor composition at a concentration of from about 1 wt. % to about 10 wt. %, based on the total amount of the polar solvent, the corrosion inhibitor, the scale inhibitor, the stabilizing corrosion inhibitor, and the stabilizing agent.

The inhibitor compositions can have the corrosion inhibitor comprise the carboxyl alkene-alkanoic acid compound and the carboxyl alkene-alkanoic acid compound be present in the inhibitor composition at a concentration of from about 2 wt. % to about 5 wt. %, based on the total amount of the polar solvent, the corrosion inhibitor, the scale inhibitor, the stabilizing corrosion inhibitor, and the stabilizing agent.

The inhibitor compositions can have the corrosion inhibitor comprise the organic sulfur compound and the organic sulfur compound is present in the inhibitor composition at a concentration of from about 0.1 wt. % to about 15 wt. %, based on the total amount of the polar solvent, the corrosion inhibitor, the scale inhibitor, the stabilizing corrosion inhibitor, and the stabilizing agent.

The inhibitor compositions can also have the corrosion inhibitor comprise the organic sulfur compound and the organic sulfur compound be present in the inhibitor composition at a concentration of from about 1 wt. % to about 10 wt. %, based on the total amount of the polar solvent, the corrosion inhibitor, the scale inhibitor, the stabilizing corrosion inhibitor, and the stabilizing agent.

The organic sulfur compound can comprise 2-mercaptoethanol.

The inhibitor compositions can have the stabilizing corrosion inhibitor comprise the alkyl amine compound and the alkyl amine compound be present in the inhibitor composition at a concentration of from about 1 wt. % to about 15 wt. %, based on the total amount of the polar solvent, the corrosion inhibitor, the scale inhibitor, the stabilizing corrosion inhibitor, and the stabilizing agent.

The inhibitor compositions described herein can have the stabilizing corrosion inhibitor comprise the alkyl amine compound and the alkyl amine compound be present in the inhibitor composition at a concentration of from about 1 wt. % to about 10 wt. %, based on the total amount of the polar solvent, the corrosion inhibitor, the scale inhibitor, the stabilizing corrosion inhibitor, and the stabilizing agent.

The alkyl amine compound can comprise a substituted alkylamine (e.g., morpholine), a substituted aromatic amine (e.g., quaternized alkyl pyridine), or a substituted alkylhydroxyl amine (e.g., diethylhydroxyl amine).

The inhibitor compositions can have the inhibitor composition further comprise the stabilizing agent, the stabilizing agent comprise the phosphate ester, and the phosphate ester be present in the inhibitor composition at a concentration of from about 1 wt. % to about 15 wt. %, based on the total amount of the polar solvent, the corrosion inhibitor, the scale inhibitor, the stabilizing corrosion inhibitor, and the stabilizing agent.

The inhibitor compositions also can have the inhibitor composition further comprise the stabilizing agent, the stabilizing agent comprise the oxyalkylated compound, and the oxyalkylated compound be present in the inhibitor composition at a concentration of from about 1 wt. % to about 5 wt. %, based on the total amount of the polar solvent, the corrosion inhibitor, the scale inhibitor, the stabilizing corrosion inhibitor, and the stabilizing agent.

The inhibitor compositions can have the inhibitor composition further comprise the stabilizing agent, the stabilizing agent comprise the dialkyl sulfosuccinate, and the dialkyl sulfosuccinate is present in the inhibitor composition at a concentration of from about 0.1 wt. % to about 5 wt. %, based on the total amount of the polar solvent, the corrosion inhibitor, the scale inhibitor, the stabilizing corrosion inhibitor, and the stabilizing agent.

Additionally, the inhibitor compositions can have the inhibitor composition further comprise the stabilizing agent, the stabilizing agent comprise the organic sulfonic acid, and the organic sulfonic acid be present in the inhibitor composition at a concentration of from about 1 wt. % to about 10 wt. %, based on the total amount of the polar solvent, the corrosion inhibitor, the scale inhibitor, the stabilizing corrosion inhibitor, and the stabilizing agent.

The organic sulfonic acid can comprise an alkylbenzene sulfonic acid, preferably a linear alkylbenzene sulfonic acid.

The inhibitor compositions can have the scale inhibitor comprise the polymer derived from a dicarboxylic acid and an allyl sulfonate, and the polymer derived from a dicarboxylic acid and an allyl sulfonate be present in the inhibitor composition at a concentration of from about 1 wt. % to about 20 wt. %, based on the total amount of the polar solvent, the corrosion inhibitor, the scale inhibitor, the stabilizing corrosion inhibitor, and the stabilizing agent.

The inhibitor compositions can have the scale inhibitor comprise the polymer derived from a dicarboxylic acid and an allyl sulfonate, and the polymer derived from a dicarboxylic acid and an allyl sulfonate be present in the inhibitor composition at a concentration of from about 1 wt. % to about 15 wt. %, based on the total amount of the polar solvent, the corrosion inhibitor, the scale inhibitor, the stabilizing corrosion inhibitor, and the stabilizing agent.

The inhibitor compositions described herein can have the scale inhibitor comprise the polycarboxylate, and the polycarboxylate be present in the inhibitor composition at a concentration of from about 1 wt. % to about 15 wt. %, based on the total amount of the polar solvent, the corrosion inhibitor, the scale inhibitor, the stabilizing corrosion inhibitor, and the stabilizing agent.

The inhibitor compositions can have the scale inhibitor comprise the amine phosphonate, and the amine phosphonate be present in the inhibitor composition at a concentration of from about 1 wt. % to about 12 wt. %, based on the total amount of the polar solvent, the corrosion inhibitor, the scale inhibitor, the stabilizing corrosion inhibitor, and the stabilizing agent.

The amine phosphonate can include sodium diethylenetriamine penta(methylenephosphonate), potassium diethylenetriamine penta(methylenephosphonate), or a combination thereof.

The inhibitor compositions also can have the scale inhibitor comprise the polyamino polyether alkylene phosphonic acid, and the polyamino polyether alkylene phosphonic acid be present in the inhibitor composition at a concentration of from about 1 wt. % to about 25 wt. %, based on the total amount of the polar solvent, the corrosion inhibitor, the scale inhibitor, the stabilizing corrosion inhibitor, and the stabilizing agent.

The inhibitor compositions can have the scale inhibitor comprise the polyalkylene polycarboxylate and the polyalkylene polycarboxylate be present in the inhibitor composition at a concentration of from about 0.2 wt. % to about 5 wt. %, based on the total amount of the polar solvent, the corrosion inhibitor, the scale inhibitor, the stabilizing corrosion inhibitor, and the stabilizing agent.

The polyalkylene polycarboxylate can be tetrasodium ethylenediamine tetraacetate, tetrapotassium, ethylenediamine tetraacetate, or a combination thereof.

The inhibitor compositions can have the inhibitor composition has a viscosity from about 3 cP to about 260 cP when measured at 4° C. and 60° C. with variable pressure, up to 20,000 psi.

In the high-pressure viscosity test, the viscosity of the selected chemical was measured at pressures ranging from 0 to 20,000 psi at 40° F. (4° C.) and 120° F. (60° C.). The viscosity of simple fluids varies exponentially with pressure. Their behavior in a defined pressure range can be described by the Barus equation:

μ_{P}=μ₀e^{βP}
Where:
μ_{P} is the viscosity at pressure P;
μ₀ is the viscosity at atmospheric pressure; and
β is the pressure coefficient (typically 10⁻⁸ to 10⁻⁹ Pa⁻¹).

The inhibitor compositions described herein can have the inhibitor composition has a viscosity that is substantially similar over a period of several hours (up to 24 hours) at a pressure of about 10,000 psi and a temperature of about seabed temperature of about 4° C. This test is conducted to understand the viscosity of a product remain constant over time, indicating stability of the product even after extended pressurization time.

The inhibitor compositions can have the composition be stable as defined by no precipitation of any components, no phase separation of the composition, and no particle formation while the composition remains flowable after the pressure is reduced to 100 mbar or less.

Also disclosed are methods of inhibiting corrosion and scale deposition comprising contacting the inhibitor compositions disclosed herein with a hydrocarbon fluid in a subterranean hydrocarbon-containing reservoir.

The methods of inhibiting corrosion and scale deposition can have the inhibitor composition inhibits carbon dioxide and hydrogen sulfide corrosion at a temperature of from about 77° F. to about 400° F. and a pressure from 0 psi to about 30,000 psi.

The methods of inhibiting corrosion and scale deposition can have the inhibitor composition inhibits calcite or barite formation.

The methods of inhibiting corrosion and scale deposition can have the inhibitor composition be injected into the subterranean hydrocarbon-containing reservoir through an umbilical line, wherein the umbilical line is at least 100 feet long, at least 500 feet long, at least 1000 feet long, and up to 50,000 feet long, or up to many miles long, or more and having an inner diameter of from about 0.25 inch to 1 inch, preferably, from about 0.5 inch to about 0.75 inch.

Also, in the methods of inhibiting corrosion and scale deposition in a subterranean hydrocarbon-containing reservoir, the inhibitor composition can inhibit or reduce corrosion in a piece of equipment in contact with the reservoir.

The inhibitor compositions described herein can be administered to a reservoir with various agents simultaneously or close in time. For example, the inhibitor compositions can be administered with an agent selected from the group consisting of an organic solvent, a corrosion inhibitor, an asphaltene inhibitor, a paraffin inhibitor, a scale inhibitor, an emulsifier, a water clarifier, a dispersant, an emulsion breaker, a gas hydrate inhibitor, a biocide, a pH modifier, a surfactant, and a combination thereof.

The agent can comprise an organic solvent. The organic solvent can comprise an alcohol, a hydrocarbon, a ketone, an ether, an alkylene glycol, a glycol ether, an amide, a nitrile, a sulfoxide, an ester, or a combination thereof. Examples of suitable organic solvents include, but are not limited to, methanol, ethanol, propanol, isopropanol, butanol, 2-ethylhexanol, hexanol, octanol, decanol, 2-butoxyethanol, methylene glycol, ethylene glycol, 1,2-propylene glycol, 1,3-propylene glycol, diethyleneglycol monomethyl ether, diethylene glycol monoethyl ether, ethylene glycol monobutyl ether, ethylene glycol dibutyl ether, pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, or a combination thereof.

The agent can comprise a corrosion inhibitor.

The corrosion inhibitor can comprise an imidazoline compound, a quaternary ammonium compound, a pyridinium compound, or a combination thereof.

The corrosion inhibitor can comprise an imidazoline. The imidazoline can be, for example, imidazoline derived from a diamine, such as ethylene diamine (EDA), diethylene triamine (DETA), triethylene tetraamine (TETA) etc. and a long chain fatty acid such as tall oil fatty acid (TOFA). The imidazoline can be an imidazoline of Formula (I) or an imidazoline derivative. Representative imidazoline derivatives include an imidazolinium compound of Formula (II) or a bis-quaternized compound of Formula (III).

The corrosion inhibitor can include an imidazoline of Formula (I):

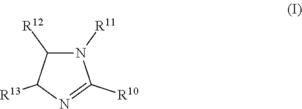

wherein R¹⁰ is a C₁-C₂₀ alkyl or a C₁-C₂₀ alkoxyalkyl group; R¹¹ is hydrogen, C₁-C₆ alkyl, C₁-C₆ hydroxyalkyl, or C₁-C₆ arylalkyl; and R¹² and R¹³ are independently hydrogen or a C₁-C₆ alkyl group. Preferably, the imidazoline includes an R¹⁰, which is the alkyl mixture typical in tall oil fatty acid (TOFA), and R¹¹, R¹² and R¹³ are each hydrogen.

The corrosion inhibitor can include an imidazolinium compound of Formula (II):

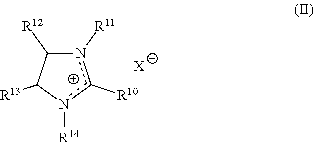

wherein R¹⁰ is a C₁-C₂₀ alkyl or a C₁-C₂₀ alkoxyalkyl group; R¹¹ and R¹⁴ are independently hydrogen, C₁-C₆ alkyl, C₁-C₆ hydroxyalkyl, or C₁-C₆ arylalkyl; R¹² and R¹³ are independently hydrogen or a C₁-C₆ alkyl group; and X⁻ is a halide (such as chloride, bromide, or iodide), carbonate, sulfonate, phosphate, or the anion of an organic carboxylic acid (such as acetate). Preferably, the imidazolinium compound includes 1-benzyl-1-(2-hydroxyethyl)-2-tall-oil-2-imidazolinium chloride.

The corrosion inhibitor can comprise a bis-quaternized compound having the formula (III):

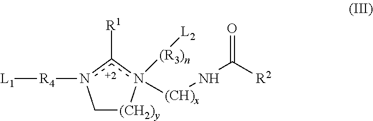

wherein R₁ and R₂ are each independently unsubstituted branched, chain or ring alkyl or alkenyl having from 1 to about 29 carbon atoms; partially or fully oxygenized, sulfurized, and/or phosphorylized branched, chain, or ring alkyl or alkenyl having from 1 to about 29 carbon atoms; or a combination thereof; R³ and R⁴ are each independently unsubstituted branched, chain or ring alkylene or alkenylene having from 1 to about 29 carbon atoms; partially or fully oxygenized, sulfurized, and/or phosphorylized branched, chain, or ring alkylene or alkenylene having from 1 to about 29 carbon atoms; or a combination thereof, L₁ and L₂ are each independently absent, H, —COOH, —SO₃H, —PO₃H₂, —COOR⁵, —CONH₂, —CONHR₅, or —CON(R⁵)₂; R⁵ is each independently a branched or unbranched alkyl, aryl, alkylaryl, alkylheteroaryl, cycloalkyl, or heteroaryl group having from 1 to about 10 carbon atoms; n is 0 or 1, and when n is 0, L₂ is absent or H; x is from 1 to about 10; and y is from 1 to about 5. Preferably, R₁ and R₂ are each independently C₆-C₂₂ alkyl, C₈-C₂₀ alkyl, C₁₂-C₁₈ alkyl, C₁₆-C₁₈ alkyl, or a combination thereof, R³ and R⁴ are C₁-C₁₀ alkylene, C₂-C₈ alkylene, C₂-C₆ alkylene, or C₂-C₃ alkylene; n is 0 or 1; x is 2; y is 1; R³ and R⁴ are —C₂H₂—; L₁ is —COOH, —SO₃H, or —PO₃H₂; and L₂ is absent, H, —COOH, —SO₃H, or —PO₃H₂. For example, R₁ and R₂ can be derived from a mixture of tall oil fatty acids and are predominantly a mixture of C₁₇H₃₃ and C₁₇H₃₁ or can be C₁₆-C₁₈ alkyl; R³ and R⁴ can be C₂-C₃ alkylene such as —C₂H₂—; n is 1 and L₂ is —COOH or n is 0 and L₂ is absent or H; x is 2; y is 1; R³ and R⁴ are —C₂H₂—; and L₁ is —COOH.

It should be appreciated that the number of carbon atoms specified for each group of formula (III) refers to the main chain of carbon atoms and does not include carbon atoms that may be contributed by substituents.

The corrosion inhibitor can comprise a bis-quaternized imidazoline compound having the formula (III) wherein R₁ and R₂ are each independently C₆-C₂₂ alkyl, C₈-C₂₀ alkyl, C₁₂-C₁₈ alkyl, or C₁₆-C₁₈ alkyl or a combination thereof; R⁴ is C₁-C₁₀ alkylene, C₂-C₈ alkylene, C₂-C₆ alkylene, or C₂-C₃ alkylene; x is 2; y is 1; n is 0; L₁ is —COOH, —SO₃H, or —PO₃H₂; and L₂ is absent or H. Preferably, a bis-quaternized compound has the formula (III) wherein R₁ and R₂ are each independently C₁₆-C₁₈ alkyl; R₄ is —C₂H₂—; x is 2; y is 1; n is 0; L₁ is —COOH, —SO₃H, or —PO₃H₂ and L₂ is absent or H.

The corrosion inhibitor can be a quaternary ammonium compound of Formula (IV).

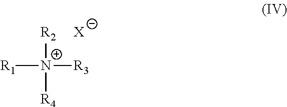

wherein R₁, R₂, and R₃ are independently C₁ to C₂₀ alkyl, R₄ is methyl or benzyl, and X⁻ is a halide or methosulfate.

Suitable alkyl, hydroxyalkyl, alkylaryl, arylalkyl or aryl amine quaternary salts include those alkylaryl, arylalkyl and aryl amine quaternary salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I. For the quaternary salts, R^{5a}, R^{6a}, R^{7a}, and R^{8a} can each be independently selected from the group consisting of alkyl (e.g., C₁-C₁₈ alkyl), hydroxyalkyl (e.g., C₁-C₁₈ hydroxyalkyl), and arylalkyl (e.g., benzyl). The mono or polycyclic aromatic amine salt with an alkyl or alkylaryl halide include salts of the formula [N⁺R^{5a}R^{6a}R^{7a}R^{8a}][X⁻] wherein R^{5a}R^{6a}R^{7a}, and R^{8a} contain one to 18 carbon atoms and at least one aryl group, and X is Cl, Br or I.

Suitable quaternary ammonium salts include, but are not limited to, a tetramethyl ammonium salt, a tetraethyl ammonium salt, a tetrapropyl ammonium salt, a tetrabutyl ammonium salt, a tetrahexyl ammonium salt, a tetraoctyl ammonium salt, a benzyltrimethyl ammonium salt, a benzyltriethyl ammonium salt, a phenyltrimethyl ammonium salt, a phenyltriethyl ammonium salt, a cetyl benzyldimethyl ammonium salt, a hexadecyl trimethyl ammonium salt, a dimethyl alkyl benzyl quaternary ammonium salt, a monomethyl dialkyl benzyl quaternary ammonium salt, or a trialkyl benzyl quaternary ammonium salt, wherein the alkyl group has about 6 to about 24 carbon atoms, about 10 and about 18 carbon atoms, or about 12 to about 16 carbon atoms. The quaternary ammonium salt can be a benzyl trialkyl quaternary ammonium salt, a benzyl triethanolamine quaternary ammonium salt, or a benzyl dimethylaminoethanolamine quaternary ammonium salt.

The corrosion inhibitor can comprise a pyridinium salt such as those represented by Formula (V):

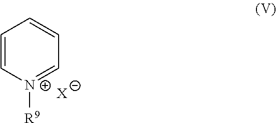

wherein R⁹ is an alkyl group, an aryl group, or an arylalkyl group, wherein said alkyl groups have from 1 to about 18 carbon atoms and X⁻ is a halide such as chloride, bromide, or iodide. Among these compounds are alkyl pyridinium salts and alkyl pyridinium benzyl quats. Exemplary compounds include methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium chloride and an alkyl benzyl pyridinium chloride, preferably wherein the alkyl is a C₁-C₆ hydrocarbyl group. Preferably, the pyridinium compound includes benzyl pyridinium chloride.

The corrosion inhibitor can include additional corrosion inhibitors such as phosphate esters, monomeric or oligomeric fatty acids, or alkoxylated amines.

The corrosion inhibitor can comprise a phosphate ester. Suitable mono-, di- and tri-alkyl as well as alkylaryl phosphate esters and phosphate esters of mono, di, and triethanolamine typically contain between from 1 to about 18 carbon atoms. Preferred mono-, di- and trialkyl phosphate esters, alkylaryl or arylalkyl phosphate esters are those prepared by reacting a C₃-C₁₈ aliphatic alcohol with phosphorous pentoxide. The phosphate intermediate interchanges its ester groups with triethylphosphate producing a broader distribution of alkyl phosphate esters.

Alternatively, the phosphate ester can be made by admixing with an alkyl diester, a mixture of low molecular weight alkyl alcohols or diols. The low molecular weight alkyl alcohols or diols preferably include C₆ to C₁₀ alcohols or diols. Further, phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine are preferred.

The corrosion inhibitor can include a monomeric or oligomeric fatty acid. Preferred monomeric or oligomeric fatty acids are C₁₄-C₂₂ saturated and unsaturated fatty acids as well as dimer, trimer and oligomer products obtained by polymerizing one or more of such fatty acids.

The corrosion inhibitor can comprise an alkoxylated amine. The alkoxylated amine can be an ethoxylated alkyl amine. The alkoxylated amine can be ethoxylated tallow amine.

The agent can comprise an organic sulfur compound, such as a mercaptoalkyl alcohol, mercaptoacetic acid, thioglycolic acid, 3,3′-dithiodipropionic acid, sodium thiosulfate, thiourea, L-cysteine, tert-butyl mercaptan, sodium thiosulfate, ammonium thiosulfate, sodium thiocyanate, ammonium thiocyanate, sodium metabisulfite, or a combination thereof. Preferably, the mercaptoalkyl alcohol comprises 2-mercaptoethanol.

The agent can further include a demulsifier. Preferably, the demulsifier comprises an oxyalkylate polymer, such as a polyalkylene glycol.

The agent can include an asphaltene inhibitor. Suitable asphaltene inhibitors include, but are not limited to, aliphatic sulfonic acids; alkyl aryl sulfonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids, salts of alkyl succinates, sorbitan monooleate, and polyisobutylene succinic anhydride.

The agent can include an additional paraffin inhibitor. Suitable additional paraffin inhibitors include, but are not limited to, paraffin crystal modifiers, and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax and/or asphaltenes. Suitable paraffin dispersants include, but are not limited to, dodecyl benzene sulfonate, oxyalkylated alkylphenols, and oxyalkylated alkylphenolic resins.

The agent can include a scale inhibitor. Suitable scale inhibitors include, but are not limited to, phosphates, phosphate esters, phosphoric acids, phosphonates, phosphonic acids, polyacrylamides, salts of acrylamidomethyl propane sulfonate/acrylic acid copolymer (AMPS/AA), phosphinated maleic copolymer (PHOS/MA), and salts of a polymaleic acid/acrylic acid/acrylamidomethyl propane sulfonate terpolymer (PMA/AA/AMPS).

The agent can include an emulsifier. Suitable emulsifiers include, but are not limited to, salts of carboxylic acids, products of acylation reactions between carboxylic acids or carboxylic anhydrides and amines, and alkyl, acyl and amide derivatives of saccharides (alkyl-saccharide emulsifiers).

The agent can include a water clarifier. Suitable water clarifiers include, but are not limited to, inorganic metal salts such as alum, aluminum chloride, and aluminum chlorohydrate, or organic polymers such as acrylic acid based polymers, acrylamide based polymers, polymerized amines, alkanolamines, thiocarbamates, and cationic polymers such as diallyldimethylammonium chloride (DADMAC).

The agent can include a dispersant. Suitable dispersants include, but are not limited to, aliphatic phosphonic acids with 2-50 carbons, such as hydroxyethyl diphosphonic acid, and aminoalkyl phosphonic acids, e.g. polyaminomethylene phosphonates with 2-10 N atoms e.g. each bearing at least one methylene phosphonic acid group; examples of the latter are ethylenediamine tetra(methylene phosphonate), diethylenetriamine penta(methylene phosphonate), and the triamine- and tetramine-polymethylene phosphonates with 2-4 methylene groups between each N atom, at least 2 of the numbers of methylene groups in each phosphonate being different. Other suitable dispersion agents include lignin, or derivatives of lignin such as lignosulfonate and naphthalene sulfonic acid and derivatives.

The agent can include an emulsion breaker. Suitable emulsion breakers include, but are not limited to, dodecylbenzylsulfonic acid (DDBSA), the sodium salt of xylenesulfonic acid (NAXSA), epoxylated and propoxylated compounds, anionic, cationic and nonionic surfactants, and resins, such as phenolic and epoxide resins.

The agent can include a hydrogen sulfide scavenger. Suitable additional hydrogen sulfide scavengers include, but are not limited to, oxidants (e.g., inorganic peroxides such as sodium peroxide or chlorine dioxide); aldehydes (e.g., of 1-10 carbons such as formaldehyde, glyoxal, glutaraldehyde, acrolein, or methacrolein; triazines (e.g., monoethanolamine triazine, monomethylamine triazine, and triazines from multiple amines or mixtures thereof); condensation products of secondary or tertiary amines and aldehydes, and condensation products of alkyl alcohols and aldehydes.

The agent can include a gas hydrate inhibitor. Suitable gas hydrate inhibitors include, but are not limited to, thermodynamic hydrate inhibitors (THI), kinetic hydrate inhibitors (KHI), and anti-agglomerates (AA). Suitable thermodynamic hydrate inhibitors include, but are not limited to, sodium chloride, potassium chloride, calcium chloride, magnesium chloride, sodium bromide, formate brines (e.g. potassium formate), polyols (such as glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, triglycerol, and sugar alcohols (e.g. sorbitol, mannitol)), methanol, propanol, ethanol, glycol ethers (such as diethyleneglycol monomethylether, ethyleneglycol monobutylether), and alkyl or cyclic esters of alcohols (such as ethyl lactate, butyl lactate, methylethyl benzoate).

The agent can include a kinetic hydrate inhibitor. Suitable kinetic hydrate inhibitors and anti-agglomerates include, but are not limited to, polymers and copolymers, polysaccharides (such as hydroxyethylcellulose (HEC), carboxymethylcellulose (CMC), starch, starch derivatives, and xanthan), lactams (such as polyvinylcaprolactam, polyvinyl lactam), pyrrolidones (such as polyvinyl pyrrolidone of various molecular weights), surfactants (such as fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, alkyl amido betaines), hydrocarbon based dispersants (such as lignosulfonates, iminodisuccinates, polyaspartates), amino acids, and proteins.

The agent can include a biocide. Suitable biocides include, but are not limited to, oxidizing and non-oxidizing biocides. Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., 2-bromo-2-nitropropane-3-diol (Bronopol) and 2-2-dibromo-3-nitrilopropionamide (DBNPA)), sulfur compounds (e.g., isothiazolone, carbamates, and metronidazole), and quaternary phosphonium salts (e.g., tetrakis(hydroxymethyl)-phosphonium sulfate (THPS)). Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, peroxides, biguanine, formaldehyde releasing preservatives, performic acid, peracetic acid, nitrate, and combinations thereof.

The agent can include a pH modifier. Suitable pH modifiers include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. Exemplary pH modifiers include sodium hydroxide, potassium hydroxide, calcium hydroxide, calcium oxide, sodium carbonate, potassium carbonate, sodium bicarbonate, potassium bicarbonate, magnesium oxide, and magnesium hydroxide.

The agent can include a surfactant. Suitable surfactants include, but are not limited to, anionic surfactants and nonionic surfactants. Anionic surfactants include alkyl aryl sulfonates, olefin sulfonates, paraffin sulfonates, alcohol sulfates, alcohol ether sulfates, alkyl carboxylates and alkyl ether carboxylates, and alkyl and ethoxylated alkyl phosphate esters, and mono and dialkyl sulfosuccinates and sulfosuccinamates. Nonionic surfactants include alcohol alkoxylates, alkylphenol alkoxylates, block copolymers of ethylene, propylene and butylene oxides, alkyl dimethyl amine oxides, alkyl-bis(2-hydroxyethyl)amine oxides, alkyl amidopropyl dimethyl amine oxides, alkylamidopropyl-bis(2-hydroxyethyl)amine oxides, alkyl polyglucosides, polyalkoxylated glycerides, sorbitan esters and polyalkoxylated sorbitan esters, and alkoyl polyethylene glycol esters and diesters. Also included are betaines and sultanes, amphoteric surfactants such as alkyl amphoacetates and amphodiacetates, alkyl amphopropionates and amphodipropionates, and alkyliminodipropionate.

The agent can also include an iron chelator. The iron chelator can be selected from gluconic acid, citric acid, ascorbic acid, tetrakis(hydroxymethyl)phosphonius sulfate (THPS), and combinations thereof.

Compositions used in the methods described herein can further include additional functional agents or additives that provide a beneficial property. For example, additional agents or additives can be sequestrants, solubilizers, lubricants, buffers, cleaning agents, rinse aids, preservatives, binders, thickeners or other viscosity modifiers, processing aids, carriers, water-conditioning agents, foam inhibitors or foam generators, threshold agents or systems, aesthetic enhancing agents (i.e., dyes, odorants, perfumes), or other additives suitable for formulation with a corrosion inhibitor composition, and mixtures thereof. Additional agents or additives will vary according to the particular corrosion inhibitor composition being manufactured and its intend use as one skilled in the art will appreciate.

Alternatively, the compositions used in the methods described herein can not contain any of the additional agents or additives.

Unless otherwise indicated, an alkyl group as described herein alone or as part of another group is an optionally substituted linear saturated monovalent hydrocarbon substituent containing from one to sixty carbon atoms and preferably one to thirty carbon atoms in the main chain or eight to thirty carbon atoms in the main chain, or an optionally substituted branched saturated monovalent hydrocarbon substituent containing three to sixty carbon atoms, and preferably eight to thirty carbon atoms in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The term alkoxy as used herein or alone or as part of another group is an —OR group, wherein the R group is a substituted or unsubstituted alkyl group as defined herein.

The terms “aryl” or “ar” as used herein alone or as part of another group (e.g., aralkyl) denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are the more preferred aryl. The term “aryl” also includes heteroaryl.

The term “substituted” as in “substituted aryl,” “substituted alkyl,” and the like, means that in the group in question (i.e., the alkyl, aryl or other group that follows the term), at least one hydrogen atom bound to a carbon atom is replaced with one or more substituent groups such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like. When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The term “heterocyclo,” “heterocycle,” or “heterocyclyl,” as used herein, refers to a monocyclic, bicyclic, or tricyclic group containing 1 to 4 heteroatoms selected from N, O, S(O)ₙ, P(O)ₙ, PR^{z}, NH or NR^{z}, wherein R^{z} is a suitable substituent. Heterocyclic groups include, but are not limited to, 1,3-oxazetidine, 1,3-diazetidine, 1,3-thiazetidine, oxazolidine, imidazolidine, thiazolidine, 1,3-oxazinane, hexahydropyrimidine, 1,3-thiazinane, 1,3-oxazepane, 1,3-diazepane, 1,3-thiazepane, 1,3-oxazocane, 1,3-diazocane, 1,3-thiazocane. Heterocyclic groups can be unsubstituted or substituted by one or more suitable substituents, preferably 1 to 3 suitable substituents, as defined above.

Having described the disclosure in detail, it will be apparent that modifications and variations are possible without departing from the scope of the invention defined in the appended claims.

### EXAMPLES

The following non-limiting examples are provided to further illustrate the present disclosure.

### Materials:

The following compositions were used in the Examples

| | Product | | | | | | | | |
|---|---|---|---|---|---|---|---|---|---|
| | 26B | 63B | 59A | 96A | 99F | 59D | 62C | 63C | 62E |
| Component | Wt % | Wt % | Wt % | Wt % | Wt % | Wt % | Wt % | Wt % | Wt % |
| MEG | 23 | 23 | 23.5 | 14 | 14 | 23 | 23 | 23 | 23 |
| (monoethylene | | | | | | | | | |
| glycol) | | | | | | | | | |
| methanol | 10 | 10 | 8 | 9.1 | 14 | 8 | 0 | 10.0 | 10 |
| Water | 31.8 | 9.5 | 30.5 | 17.2 | 14 | 22.5 | 11.0 | 10.0 | 16.6 |
| Fatty acid- | 5 | 14 | 5 | 14 | 14 | 10 | 14.0 | 14.0 | 14 |
| amine | | | | | | | | | |
| condensate | | | | | | | | | |
| N-Benzyl- | | 5 | | 2.5 | 2.5 | | 10.0 | 0 | 8 |
| Alkylpyridinium | | | | | | | | | |
| Chloride | | | | | | | | | |
| Quaternary | 2.5 | 10 | | 6.8 | 10 | 5 | 10.0 | 14.0 | 6.4 |
| Ammonium | | | | | | | | | |
| compounds | | | | | | | | | |
| Carboxyl | 2.5 | 2.5 | 2.5 | 4.1 | | 2.5 | 2.5 | 5.0 | 2.5 |
| Cyclohexene- | | | | | | | | | |
| Octanoic Acid | | | | | | | | | |
| Organic sulfur | 2.5 | 2.5 | 1.5 | 3.4 | 2.5 | 2.5 | 2.5 | 2.5 | 2.5 |
| compound | | | | | | | | | |
| Substituted | 5 | 0 | 2.5 | | | 2.5 | | 2.5 | |
| aromatic amine | | | | | | | | | |
| Substituted | 8.2 | 5 | 10 | 7.9 | 2.5 | 2.5 | | 2.5 | 2.5 |
| alkylamine | | | | | | | | | |
| Substituted | | 0.5 | | 1 | | 2.5 | 0 | 0 | |
| alkylhydroxyl | | | | | | | | | |
| amine | | | | | | | | | |
| Phosphates | 2.5 | 1.5 | 2.5 | 1.5 | 2.5 | 2.5 | 2.5 | 1.5 | 1.5 |
| (Ethoxylated | | | | | | | | | |
| branched | | | | | | | | | |
| nonylphenol) | | | | | | | | | |
| Oxyalkylated | | | | 2 | 2.5 | | | | 2.5 |
| derivative | | | | | | | | | |
| Dioctyl Sodium | 0.5 | 0 | 0 | | | | 0.5 | | 0.5 |
| Sulfonsuccinate | | | | | | | | | |
| Organic | 1.5 | 2.5 | | 1.5 | | | | | |
| sulfonic acid | | | | | | | | | |
| Fumaric Acid, | 5 | 14 | 14 | 5 | | 14 | | 15 | 10 |
| polymer with | | | | | | | | | |
| Na | | | | | | | | | |
| allylsulfonate | | | | | | | | | |
| Proprietary | | 0 | 0 | | | 2.5 | | | |
| polycarboxylate | | | | | | | | | |
| salt in water | | | | | | | | | |
| Amine | | | | 10 | | | | | |
| Phosphonate | | | | | | | | | |
| Polyamino | | | 0 | | 21.5 | | 14.0 | | |
| polyether | | | | | | | | | |
| methylene | | | | | | | | | |
| phosphonic acid | | | | | | | | | |
| derivative | | | | | | | | | |

The components are available from various sources. For example, the fatty acid-amine condensate is described above as the bis-quaternized compound of Formula III, the N-Benzyl-Alkylpyridinium chloride is shown as the pyridinium salt of Formula V, and the quaternary ammonium compound is described above as the compound of Formula IV. Further, the carboxyl cyclohexene-octanoic acid is available from Atrachem as Latol 1550 or from Westvaco Chemicals as Diacid 1550. The organic sulfur compound can be Basocorr™ ME (i.e., 2-Mercaptoethanol). The substituted aromatic amine is available from Lonza as ALKOLIDINE 11 (e.g., quaternized alkyl pyridine) or from Vertellus as PAP 220 (e.g., alkylpyridine mixture). The substituted alkylamine can be morpholine. The substituted alkylhydroxyl amine is diethylhydroxyl amine (e.g., AQ-DEHA). The phosphate, particularly ethoxylated branched nonylphenol is available from Huntsman as SURFONIC® PE-1198LA. The oxyalkylated derivative is available from Dow as TERGITOL™ NP-9.5, from Oxiteno as ULTRANEX® FP 95 (i.e., ethoxylated nonylphenol), from Dow as TERGITOL™ NP (i.e., nonylphenol ethoxylate), from Sigma-Aldrich as IGEPAL® CO-630 (i.e., alkylphenol ethoxylate), from Oxiteno as ULTRANEX® NP 95, from Sino-Japan Chemical as SINOPOL 964H (i.e., polyoxyethylene nonylphenyl ether), or from Sasol as MARLOPHEN NP 9. The dioctyl sodium sulfosuccinate is available from MFG Manufacturing as ULTRADOSS 70 PG, from Sielc Technologies as Monawet MO-70R, from Solvay as AEROSOL® OT-70 PG, or from Flottec as Flottec 470N. The organic sulfonic acid is a linear alkylbenzene sulfonic acid. The fumaric acid polymer with Na allylsulfonate is available from Stakem as Discoscale SI 7331 or from Kemira as KEMGUARD® 269. The polycarboxylate salt is available from BASF as Basoscale BA 100. The amine phosphate is available from Italmatch as MAYOQUEST® 2200.

### Methods:

Rotating Cage Autoclave (RCA) Test for Corrosion Inhibitor Performance Evaluation. RCA uses pre-weighed coupons that are mounted on a special holder. The coupon assembly was attached to the rotating shaft and placed into the test autoclave that was previously deaerated in three cycles by nitrogen. The autoclave was then sealed and flushed with N₂ gas to remove any oxygen before pressure testing under N₂ pressure of approximately 200 psi. If no drop in pressure occurs, pressure was released, a N₂ purge was maintained and the desired ratio of CO₂ sparged synthetic brine and hydrocarbon were added to the vessel followed by direct autoclave dosing of the appropriate chemicals. The autoclave was stirred at lower speed while allowing to heat to the test temperature. Once temperature stabilized, coupons were rotated at a speed corresponding to a desired wall shear stress. An appropriate amount of CO₂ and/or H₂S was then added on top of the stabilized gauge pressure at temperature until it was stabilized at the target pressure. The test was then allowed to proceed for the required length of time.

After the appropriate test duration, the autoclave was cooled down and depressurized. Coupons were removed, cleaned in inhibited hydrochloric acid, dried, and weighed to obtain general corrosion rate. Additionally, the weight loss samples were evaluated for localized corrosion.

Materials Compatibility Testing for Neat Chemical Corrosivity. Materials compatibility testing was done to determine if the selected inhibitor was likely to pose a threat to the integrity of the materials of construction using the following test protocol.

Metal coupons were visually inspected, pre-weighed and then mounted on a tree assembly before being fully submerged in bottles of the test chemistries. The bottles were capped, sealed and samples were placed in ovens for testing. After the appropriate test duration, the coupons were removed from the oven, cooled, cleaned, visually inspected, weighed, and photographed. The general corrosion rate was estimated based on the weight loss of individual coupons following the equation as shown below.

$$mpy ( mills per year ) = \frac{534 W}{DAT}$$

Where W=Weight loss (mg)
D=Metal density of coupon (g/cm3)
A=Area of coupon (cm2)
T=Period of exposer (hours)

White Light Interferometry (WLI) for Localized Corrosion Assessment. A Bruker optical three-dimensional surface profilometer NPFlex-LA was used for characterizing metal coupon surface features. The surface-scanning technique based on Vertical scanning interferometry (VSI) provided non-contact, quantitative measurements with a micron resolution in the vertical axis.

The NPFlex-LA determined the size and shape of the surface features over the whole scan area. Interferometry scanned the entire coupon surface and quantitatively reported regions or features that deviate from the average surface baseline of the coupon. Not all surface features should be identified as a “pit” or “pitting corrosion,” as very minor changes in the surface structure may be labeled as a deviation from the average surface plane. These features may include inclusion complexes in the metal, grain structure lines, or imperfections, due to the surface finish technique. The scanning process identifies the topography of the surface, and post-scanning filtration of the data set allows for differentiation of scanning noise versus well defined, localized corrosion or pitting corrosion.

A description of surface features via these parameters was intended to give a more quantitative representation of the overall surface quality after exposing the coupon with different chemistry.

Dynamic Scale Loop (DSL) Testing for Scale Inhibitor Performance Evaluation. Dynamic Scale Loop was chosen as the preferred method to determine scale inhibition properties of each chemical. The test is widely used in the industry to determine the tendency of synthetic waters to form scale in a capillary at defined temperatures and pressures. The apparatus can also be used to determine the effectiveness of scale inhibiting additives.

The DSL used a high temperature/high pressure system operating with pressures up to 3500 psi and temperatures up to 250° C. The DSL operates under the simple principle that as scale builds-up on the interior surface of the small metal capillary, a difference of pressure can be measured. A rapid pressure increase was indicative of severe scaling conditions. The DSL holds two sets of fluids contained in reservoirs on top of the unit. These are divided into the cationic and anionic brines. The cationic brine contains the scaling cations (Ca²⁺ Ba²⁺, Mg²⁺, etc.) of interest, while the anionic brine contains the scaling anions (SO₄²⁻, HCO₃⁻, etc.) the remaining ions of the brines are divided equally between the fluids to give them similar densities. The final mix of the two fluids results in the desired synthetic brine.

A typical scenario for a scaling tendency test and inhibitor evaluation was to prepare fluids, load into reservoirs on the top of the unit, set temperature and pressure parameters on the system and begin flow of deionized water. The reference differential pressure across the capillary was noted with the DI water flow at a constant flow rate through both pumps. Fluid selection was switched to cation and anion brine and a timer started for a “blank” run with no inhibitor added. The time for the fluids to form enough scale deposit to produce a significant differential pressure increase above the reference pressure is recorded. The loop was then flushed with a cleaning agent to remove scale deposit from the coil, the flushed and reloaded with deionized water to completely remove any residual. The inhibited fluids were then evaluated starting with a high concentration of inhibitor and reducing the concentration until a significant increase in differential pressure is observed. Each concentration was typically run 2-3 times the inhibited blank time. If the tested concentration did not meet the cut off pressure within the referenced scale time, the next dosage of inhibitor was evaluated until scaling is observed. The recommended minimum effective dosage (MED) was the lowest tested concentration with no increase in differential pressure after running 2-3 times the blank time.

Static Bottle Test for Scale Inhibitor Performance Evaluation. Static Bottle test was used to assess scale inhibition performance of candidate products. This is an industry-recognized evaluation methods for scale inhibitor selection especially for barite scale control. Typically, it is used to determine the effectiveness of a product based on percent (%) inhibition achieved by it. The percent inhibition reflects the amount of cation (for example Sr²⁺, Ca²⁺, Ba²⁺) retained in the solution relative to the amount of cation remaining in solution for a standard (initial cation concentration) and a blank (free precipitating sample). The efficiency of scale inhibition is thus defined as:

$$\% Efficiency ( t ) = \frac{( {C}_{I} - {C}_{B} )}{( {C}_{O} - {C}_{B} )} \times 100$$

Where:
CI=Concentration of cation at sampling
CO=Concentration of cation in original cation brine (at t=0)
CB=Concentration of cation in blank solution (i.e. no inhibitor)

Based on the value of the efficiency, the minimum effective dosage (MED) of all the screened scale inhibitors can be determined. The pass criterion for a dosage to be effective was at least 80% scale inhibitor efficiency. The MED is dependent on the test temperature, time, and the brine chemistry. The bottle test was conducted at atmospheric pressure and at room temperature using the brine composition provided in the tables below. The test was conducted for 6 hours with sampling intervals at 2 h, 4 h and 6 h. At the end of the testing, an aliquot of 2 mL was taken from each test bottle and diluted with 18 ml of quenching solution. The samples were analyzed for the cation (barium) of interest using the Inductively Coupled Plasma Optical Emission Spectrometry (ICP-OES).

Rotary Evaporator Test for assessing products for gas lift application as well as for umbilical usage under high vacuum. Due to concerns with umbilical vacuum, and gas lift application the candidates were subjected to a gunking/deposition test. The test was conducted at specific temperature, which is considered as the highest temperature the product would be exposed to in potential umbilical vacuum or gas lift scenarios. This test examines potential product instability resulting from solvent flash. The intent is to provide a relative comparison of risks (if any) between the candidate products. The test was run at the specified temperature, for example, 250° F., for duration of 4 hours. At the end of the test, samples were visually inspected for any precipitation, phase separation, or particle formation that might have occurred. The samples were assessed for fluidity by tilting the test flask and for observing the sample's ability to flow.

### Test Procedure References:

Rotating Cage Autoclave Testing for Corrosion Performance Evaluation

ASTM D-1141, Practice for the Preparation of Substitute Ocean Water

ASTM G-1, Standard Practice for Preparing, Cleaning, and Evaluating Corrosion Test Specimens

ASTM G-111, Standard Guide for Corrosion Tests in High Temperature or High Pressure Environment, or Both

ASTM G-170, Standard Guide for Evaluating and Qualifying Oilfield and Refining Corrosion Inhibitors in the Laboratory

ASTM G-184, Standard Practice for Evaluating and Qualifying Oil Field and Refinery Corrosion Inhibitors Using Rotating Cage

NACE-ID196, Laboratory Test Methods for Evaluating Oil-Field Corrosion Inhibitors

### White Light Interferometry for Localized Corrosion Assessment

ISO 11562: 1996, Geometrical Product Specifications (GPS)—Surface Texture: Profile Method—Metrological Characteristics of Phase Correct Filters (International Organization for Standardization, Geneva, 1996)

ASME B46.1, Surface Texture: Surface Roughness, Waviness, and Lay (American Society of Mechanical Engineers, New York, 1995)

ISO 25178-604:2013 Geometrical product specifications (GPS)—Surface texture: Areal—Part 604: Nominal characteristics of non-contact (coherence scanning interferometry) instruments

### Dynamic Scale Loop for Scale Inhibitor Performance Evaluation

DLI 10.123 Preparation of Synthetic Brines

DLI 10.129 Dosing of Scale Inhibitors

### Example 1. Corrosion Inhibition Performance Evaluation

The general procedure detailed above as the Rotating Cage Autoclave (RCA) test for testing corrosion inhibition was used. The parameters for the RCA test testing the corrosion performance at moderate shear and high temperature were as follows.

TABLE 1A
Moderate Shear and High Temperature RCA Test Conditions

| Parameter | Values | |
|---|---|---|
| Methodology | RCA | |
| Temperature | 82° | C. (180° F.) |
| Metallurgy | X-65 | |
| Brine | Synthetic Brine | |
| Water Cut | 99% | |
| Shear | 25 | Pa |
| Partial Pressure CO2 | 20 | psi |
| Duration | 7 | days |
| Dosage | 100-150 | ppm (based on total fluid) |

The synthetic brine used for the RCA test that tested the corrosion performance at moderate shear and high temperature had the following composition.

TABLE 1B
Synthetic Water Composition

| Ion | Concentration |
|---|---|
| Na⁺ | 12000 |
| K⁺ | 94 |
| Ca²⁺ | 120 |
| Mg²⁺ | 45 |
| Sr²⁺ | 35 |
| Cl⁻ | 16900 |
| HCO₃²⁻ | 700 |
| OAc⁻ | 790 |

The results of the RCA test that tested the corrosion performance at moderate shear and high temperature follow.

TABLE 1C
Moderate Shear and High Temperature RCA Corrosion Data

| | | *Average Corrosion | |
|---|---|---|---|
| Product | Dose (ppm) | Rate (mpy) | Features > 20 μm |
| Blank | N/A | 6.53 | Did not scan |
| Comparator A | 150 | 0.47 | 2, 29 |
| 26B | 100 | 0.97 | 0, 0 |
| 63B | 100 | 0.77 | 0, 0 |
| 63C | 100 | 0.90 | 0, 0 |
| 62C | 100 | 0.80 | 0, 0 |
| 62E | 100 | 0.94 | 0, 0 |

*based on 2 coupons per test

The parameters for the RCA test testing the corrosion performance at high shear and high temperature were as follows.

TABLE 2A
High Shear and High Temperature RCA Test Conditions

| Parameter | Values | |
|---|---|---|
| Methodology | RCA | |
| Temperature | 99° | C. (210° F.) |
| Metallurgy | X-65 | |
| Brine | Synthetic Brine | |
| Water Cut | 99% | |
| Wall Shear Stress | 217 | Pa |
| Partial Pressure (psig) | Fluids saturated with CO₂at room | |
| | temperature according to modelling | |
| Duration | 7 | days |
| Dosage | 200 | ppm (based on total fluid) |

The synthetic brine used in the RCA tests that tested the corrosion performance at high shear and high temperature had the following composition.

TABLE 2B
Synthetic Water Composition

| Ion | Concentration |
|---|---|
| Na⁺ | 33391 |
| K⁺ | 151 |
| Ca²⁺ | 600 |
| Mg²⁺ | 300 |
| Sr²⁺ | 51 |
| Ba²⁺ | 42 |
| Cl⁻ | 52700 |
| HCO₃²⁻ | 300 |
| OAc⁻ | 1500 |

The results of the RCA tests that tested corrosion performance at high shear and high temperature were as follows.

TABLE 2C
High Shear and High Temperature RCA Corrosion Data

| | | | *Average | | Deepest |
|---|---|---|---|---|---|
| | Dose | Corrosion | Corrosion Rate | | Feature |
| Product | (ppm) | Rate (mpy) | (mpy) | Features > 20 μm | (μm) |
| Blank | N/A | 179.20, 174.23 | 176.72 | Visible | Visible |
| | | | | pitting | pitting |
| Comparator | 200 | 1.29, 1.45 | 1.39 | 5, 12 | 25, 28.6 |
| A | | | | | |
| Comparator | 200 | 2.17, 2.18 | 2.18 | 2410, 1 | 139, 27.6 |
| B | | | | | |
| Comparator | 200 | 1.12, 1.09 | 1.10 | 16, 34 | 41.7, 73.5 |
| C | | | | | |
| 62E | 200 | 1.05, 1.33 | 1.19 | 1, 0 | 29.2, — |
| 63B | 200 | 1.31, 1.33 | 1.32 | 0, 0 | —, — |

*based on 2 coupons per test

The parameters for the RCA test testing the corrosion performance at low bicarbonate concentration were as follows.

TABLE 3A
Low Bicarbonate Concentration RCA Test Conditions

| Parameter | Values | |
|---|---|---|
| Methodology | RCA | |
| Temperature | 116° | C. (240° F.) |
| Metallurgy | C-1018 | |
| Brine | Representative Synthetic Brine | |
| Oil | LVT-200 | |
| Water Cut | 55% | |
| Shear Stress | 40 | Pa |
| Pressure CO₂ (psig) | 60 | |
| Duration | 168 | hours |
| Dosage | 150-200 | ppm (based on total fluid) |

The synthetic brine used in the RCA tests that tested the corrosion performance at low bicarbonate composition had the following composition.

TABLE 3B
Synthetic Water Composition

| Ion | Concentration |
|---|---|
| Na⁺ | 12300 |
| K⁺ | 78 |
| Ca²⁺ | 1360 |
| Mg²⁺ | 155 |
| Sr²⁺ | 211 |
| Ba²⁺ | 38 |
| Cl⁻ | 22478 |
| HCO₃²⁻ | 100 |
| SO₄²⁻ | 18 |

The results of the RCA tests that tested corrosion performance at low bicarbonate concentration were as follows.

TABLE 3C
Low Bicarbonate Concentration RCA Corrosion Data

| | | Corrosion | *Average |
|---|---|---|---|
| | Dose | Rate | Corrosion |
| Product | (ppm) | (mpy) | Rate (mpy) |
| Blank | N/A | 119.20, 125.63 | 122.37 |
| Corrosion Comparator | 150 | 5.66, 6.70 | 6.18 |
| A | | | |
| Corrosion Comparator | 150 | 27.85, 27.30 | 27.58 |
| B | | | |
| Comparator D | 200 | 62.08, 55.59 | 58.83 |
| 96A | 150 | 1.85, 1.98 | 1.92 |

*based on 2 coupons per test

The parameters for the RCA test testing the corrosion performance high shear and high temperature were as follows.

TABLE 4A
High Temperature and High Shear RCA Test Conditions

| Parameter | Values | |
|---|---|---|
| Methodology | RCA | |
| Temperature | 113° | C. (235° F.) |
| Metallurgy | X-65 | |
| Brine | Representative Synthetic Brine | |
| Oil | LVT-200 | |
| Water Cut | 90% | |
| Shear Stress | 96.7 | Pa |
| Pressure CO₂ (psig) | 19.3 | |
| Sparging Gas | N₂ | |
| Duration | 168 | hours |
| Dosage | 225-450 | ppm (total water) |

| | |
|---|---|
| Pitting Criteria | Features > 10 microns depth, |
| | diameter-to-depth ratio < 2 |

The synthetic brine used in the RCA tests that tested the corrosion performance at high shear and high temperature had the following composition.

TABLE 4B
Synthetic Water Composition

| Ion | Concentration |
|---|---|
| Na⁺ | 61863 |
| K⁺ | 914 |
| Ca²⁺ | 3387 |
| Mg²⁺ | 503 |
| Sr²⁺ | 179 |
| Ba²⁺ | 13 |
| Cl⁻ | 131000 |
| HCO₃²⁻ | 327 |
| OAc⁻ | 1200 |

The results of the RCA tests that tested corrosion performance at high shear and high temperature were as follows.

TABLE 4C
High Temperature and High Shear RCA Corrosion Data

| | | | *Average | **Deepest | |
|---|---|---|---|---|---|
| | Dose | Corrosion | Corrosion Rate | Feature | **Features > |
| Product | (ppm) | Rate (mpy) | (mpy) | (μm) | 10 μm |
| Blank | N/A | 101.2, 82.16 | 91.71 | Did not scan | Did not scan |
| Comparator | 315 | 3.98, 3.28 | 3.63 | 29.8, — | 2, 0 |
| C | | | | | |
| Comparator | 360 | 3.13, 3.13 | 3.13 | —, 19.7 | 0, 1 |
| C | | | | | |
| Comparator | 450 | 1.93, 2.15 | 2.04 | 20.7, — | 1, 0 |
| C | | | | | |
| Comparator | 450 | 2.64, 2.39 | 2.52 | —, — | 0, 0 |
| A | | | | | |
| 99F | 225 | 1.25, 1.28 | 1.26 | —, 26.0 | 0, 1 |

*based on 2 coupons per test
**for pitting features, the first number is for coupon 1 and the second number is for the second coupon.

The parameters for the RCA test testing the corrosion performance low shear and high temperature were as follows.

TABLE 5A
High Temperature and Low Shear RCA Test Conditions

| Parameter | Values | |
|---|---|---|
| Methodology | RCA | |
| Temperature | 121° | C. (250° F.) |
| Metallurgy | C1018 | |
| Brine | Representative Synthetic Brine | |
| Oil | LVT-200 | |
| Water Cut | 90% | |
| Shear Stress | 96.7 | Pa |
| Pressure CO₂ (psig) | 20 | |
| Total Pressure | 520 | psi (remaining pressure adjusted with N₂) |
| Duration | 168 | hours |
| Dosage | 100 | ppm (based on total liquid) |

The synthetic brine used in the RCA tests that tested the corrosion performance at low shear and high temperature had the following composition.

TABLE 5B
Synthetic Water Composition

| Ion | Concentration |
|---|---|
| Na⁺ | 1161 |
| Ca²⁺ | 168 |
| Mg²⁺ | 44 |
| Ba²⁺ | 2 |
| Cl⁻ | 2130 |
| HCO₃²⁻ | 137 |
| SO₄²⁻ | 10 |

The results of the RCA tests that tested corrosion performance at low shear and high temperature were as follows.

TABLE 5C
High Temperature and Low Shear RCA Corrosion Data

| | Dose | Corrosion | *Average Corrosion |
|---|---|---|---|
| Product | (ppm) | Rate (mpy) | Rate (mpy) |
| Blank | N/A | 27.66, 21.57 | 24.61 |
| 59A | 100 | 3.40, 0.95 | 2.17 |
| 59D | 100 | 0.58, 0.46 | 0.52 |

*based on 2 coupons per test

The parameters for the RCA test testing the corrosion performance high shear were as follows.

TABLE 6A
High Shear RCA Test Conditions

| Parameter | Values | |
|---|---|---|
| Methodology | RCA | |
| Temperature | 79.4° | C. |
| Metallurgy | C1018 | |
| Brine | Synthetic Brine | |
| Water Cut | 75% | |
| Shear Stress | 100 | Pa |
| Pressure CO₂ (psig) | 20 | |
| Duration | 7 | days |
| Dosage | 100 & 250 | ppm (based on water) |

The synthetic brine used in the RCA tests that tested the corrosion performance at high shear had the following composition.

TABLE 6B
Synthetic Water Composition

| Ion | Concentration |
|---|---|
| Na⁺ | 43200 |
| K⁺ | 813 |
| Ca²⁺ | 5200 |
| Mg²⁺ | 852 |
| Sr²⁺ | 598 |
| Cl⁻ | 107000 |
| HCO₃²⁻ | 580 |
| OAc⁻ | 80 |

The results of the RCA tests that tested corrosion performance at high shear were as follows.

TABLE 6C
High Shear RCA Corrosion Data

| | | *Average Corrosion |
|---|---|---|
| Product | Dose (ppm) | Rate (mpy) |
| Blank + Scale Comparator A | 100 | 8.5 |
| Comparator E | 250 | 1.84 |
| 96A | 150 | 0.70 |

*based on 2 coupons per test

The parameters for the RCA test testing the corrosion performance high shear were as follows.

TABLE 7A
High Shear RCA Test Conditions

| Parameter | Values |
|---|---|
| Methodology | RCA |
| Temperature | 175° F. (79° C.) |
| Metallurgy | C-1018 |
| Brine | Representative Synthetic Brine |
| Water Cut | 75% |
| Shear Stress | 100 Pa |
| Pressure CO₂ (psig) | 20 |
| Duration | 168 hours |
| Dosage | 100 & 250 ppm (based on water) |

The synthetic brine used in the RCA tests that tested the corrosion performance at high shear had the following composition.

TABLE 7B
Synthetic Water Composition

| Ion | Concentration |
|---|---|
| Na⁺ | 24580 |
| K⁺ | 408 |
| Ca²⁺ | 1465 |
| Mg²⁺ | 236 |
| Sr²⁺ | 392 |
| Ba²⁺ | 53.5 |
| Cl⁻ | 39249 |
| HCO₃²⁻ | 354 |
| SO₄²⁻ | 361 |
| OAc⁻ | 290 |

The results of the RCA tests that tested corrosion performance at high shear were as follows.

TABLE 7C
High Shear RCA Corrosion Data

| | | | *Average | **# of | **Deepest |
|---|---|---|---|---|---|
| | Dose | Corrosion | Corrosion | Features | Feature |
| Product | (ppm) | Rate (mpy) | Rate (mpy) | >20 μm | (μm) |
| Blank + Scale | 100 | 43.9, 45.6 | 44.8 | Not assessed | Not assessed |
| Comparator A | | | | | |
| Comparator E | 250 | 5.1, 3.6 | 4.3 | 39, 1 | 33.6, 23.5 |
| Comparator F | 250 | 14.3, 15.2 | 14.7 | Not assessed | Not assessed |
| Corrosion | 150 + 100 | 5.3, 5.6 | 5.5 | 301, 209 | 29.0, 42.5 |
| Comparator C + | | | | | |
| Scale Comparator | | | | | |
| A | | | | | |
| 63B | 150 | 2.9, 2.8 | 2.9 | 2, 0 | 26.2, — |
| 96A | 150 | 3.3, 3.2 | 3.2 | 3, 3 | 23.7, 28.6 |
| Comparator G | 150 | 10.9, 10.8 | 10.8 | Not assessed | Not assessed |
| 96A | 150 | 4.3, 4.1 | 4.2 | 0, 1 | —, 25.5 |

*based on 2 coupons
**for pitting features, the first number is for coupon 1 and the second number is for the second coupon.

### Example 2. Materials Compatibility Test (MCT) Results

The general procedure detailed above as the Materials Compatibility Test (MCT) test for testing compatibility of the products with various metals was used. The MCT results for various products at 130° C. with C-1018 steel follow.

TABLE 8A
Materials Compatibility Test (MCT)
Results at 130° C. with C-1018 Steel

| Product | # of days | Corrosion Rate (mpy) |
|---|---|---|
| 59A | 14 | 4.4 |
| 59A | 28 | 2.3 |
| Scale Comparator B | 28 | 21.7 |
| Scale Comparator C | 28 | 31.5 |
| 59D | 28 | 8.3 |

The C-1018 steel coupons treated with Product 59A used in the MCT test at 130° C. did not show signs of localized corrosion after 14 or 28 days as shown in images of the coupons. Additionally, C-1018 steel coupons treated with Product 59D used in the MCT test at 130° C. did not show signs of localized corrosion after 28 days as shown in images of the coupons.

The MCT results for various products at 120° C. with F-22 steel follow.

TABLE 9A
Materials Compatibility Test (MCT) Results at 120° C. with F-22

| Product | # of days | Corrosion Rate (mpy) |
|---|---|---|
| Comparator H | 28 | 55.4 |
| Comparator I | 28 | 12.8 |
| 59D | 28 | 2.5 |
| 59A | 28 | 2.5 |

### Example 3. Scale Inhibition Performance

The Static Bottle Test (SBT) described above was used to test the scale performance. The parameters for the SBT are detailed in the following table.

TABLE 10A
Scale Performance Evaluation in Static Bottle Test

| Parameters | Values |
|---|---|
| Test duration | 2, 6, and 24 hours |
| Temperature | 21.5° C. (69° F.) |
| Water Cut (%) | 100 |
| Brine composition | Synthetic Field Brine |
| Dose rate (ppm) | 25, 50, 75, and 100 |

The synthetic brine composition used in the SBT test is disclosed in the following table.

TABLE 10B
Synthetic Water Composition

| Ion | Concentration |
|---|---|
| Na⁺ | 24000 |
| K⁺ | 137 |
| Ca²⁺ | 849 |
| Mg²⁺ | 393 |
| Sr²⁺ | 86 |
| Ba²⁺ | 57 |
| Cl⁻ | 38300 |
| SO₄²⁻ | 75 |
| OAc⁻ | 730 |

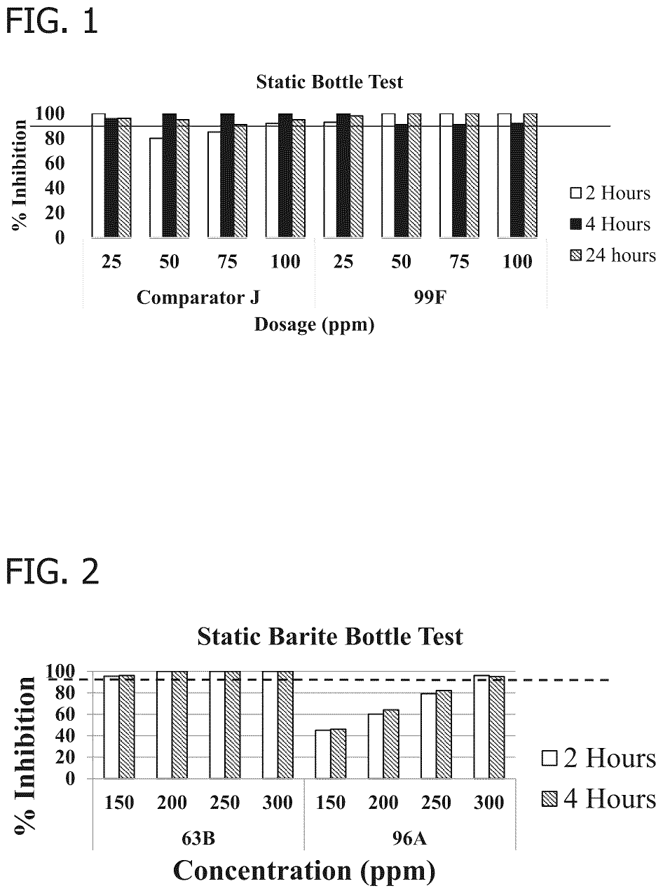

The results of the SBT test using the parameters and synthetic brine disclosed in Tables 10A and 10B are shown in FIG. 1.

The Static Bottle Test (SBT) described above was used to test the scale performance. The parameters for the SBT are detailed in the following table.

TABLE 11A
Scale Performance Evaluation in Static Bottle Test

| Parameters | Values |
|---|---|
| Test duration | 2 and 4 hours |
| Temperature | 35.5° C. (96° F.) |
| Water Cut (%) | 100 |
| pH | ~7.0 |
| Brine composition | Synthetic Field Brine |
| Dose rate (ppm) | 150, 200, and 250 |
| Passing Criteria | At least 80% scale inhibitor efficiency |

The synthetic brine composition used in the SBT test is disclosed in the following table.

TABLE 11B
Synthetic Water Composition

| Ion | Concentration |
|---|---|
| Na⁺ | 27000 |
| K⁺ | 489 |
| Ca²⁺ | 1419 |
| Mg²⁺ | 198 |
| Sr²⁺ | 802 |
| Ba²⁺ | 240 |
| Cl⁻ | 49212 |
| SO₄²⁻ | 563 |

The results of the SBT test using the parameters and synthetic brine disclosed in Tables 11A and 11B are shown in FIG. 2.

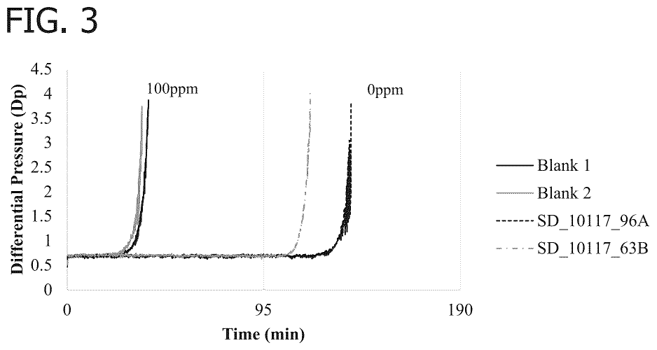

The Dynamic Scale Loop (DSL) test described above was used to determine the scale inhibiting properties of Products 96A and 63B. Both of these products passed the DSL test at 100 ppm dose rate. These results are shown in FIG. 3.

TABLE 12A
Scale Performance - DSL Testing Conditions

| Parameters | Values |
|---|---|
| Temperature | 76.6° C. (170° F.) |
| Total Fluid Flow Rate | 10 mL/min |
| Scaling Coil | 1 m length; 1 mm inner diameter |
| pH | ~7.0 |
| Brine composition | Synthetic Field Brine |
| Pressure | 1800 psi |
| Passing Criteria | Less than 1 psi dep changes over 2-3 times of |
| | blank scaling time |

The synthetic brine composition for the DSL tests is detailed below.

TABLE 12B
Synthetic Water Composition

| Ion | Concentration |
|---|---|
| Na⁺ | 27201 |
| K⁺ | 460 |
| Ca²⁺ | 2092 |
| Mg²⁺ | 298 |
| Sr²⁺ | 469 |
| Ba²⁺ | 2 |
| Cl⁻ | 38487 |
| HCO₃²⁻ | 291 |
| SO₄²⁻ | 452 |

### Example 4. Deposition Tests in High Vacuum

The procedure for the deposition test is described above. The deposition/gunking tests were performed at 37.7° C. (100° F.), a rotation speed of 250 rpm, a pressure of 100 mbar, and an initial mass of 50 grams of sample.

| | | | Final Sample | |
|---|---|---|---|---|
| Sample | Time | | Weight (g) | % Loss |
| Comparator A | 79 | minutes | 20.69 | 58.6 |
| 63B | 4 | hours | 35.15 | 29.7 |
| 99F | 4 | hours | 29.72 | 40.6 |

Comparator A showed signs of instability in the test of gelation and particulates, while Product 63B and 99F did not show signs of instability in terms of gelation and particulates.

The same deposition/gunking tests were performed at 93.3° C. (200° F.), a rotation speed of 250 rpm, a pressure of 300 mbar, and an initial mass of 50 grams of sample.

| | | Final Sample | |
|---|---|---|---|
| Sample | Time | Weight (g) | % Loss |
| 62E | 4 hours | 35.3 | 29.4 |
| 63B | 4 hours | 35.89 | 28.4 |
| 96A | 4 hours | 33.56 | 34.0 |

Products 62E, 63B, and 96A also passed the test at high temperature with no signs of instability of gelling or particulates forming.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above methods without departing from the scope of the disclosure, it is intended that all matter contained in the above description shall be interpreted as illustrative and not in a limiting sense.

1. An inhibitor composition comprising:
from about 1 wt. % to about 80 wt. % of a polar solvent;
a corrosion inhibitor comprising an amine-fatty acid condensate compound, a quaternary ammonium compound, a carboxyl alkene-alkanoic acid compound, an organic sulfur compound, a phosphate ester, or a combination thereof,
a scale inhibitor comprising a polymer derived from a dicarboxylic acid and an allyl sulfonate, a polycarboxylate, an amine phosphonate, a polyamino polyether alkylene phosphonic acid, a polyalkylene polycarboxyate, or a combination thereof, and
a stabilizing corrosion inhibitor comprising an aromatic amine, an alkylamine, a cyclic amine, an alkyl hydroxyl amine, or a combination thereof.

2. The inhibitor composition of claim 1, wherein the concentration of the polar solvent is based on the total amount of the polar solvent, the corrosion inhibitor, the scale inhibitor, and the stabilizing corrosion inhibitor.

3. The inhibitor composition of claim 1, further comprising a stabilizing agent.

4. The inhibitor composition of claim 3, wherein the stabilizing agent comprises a surfactant.

5. The inhibitor composition of claim 4, wherein the surfactant comprises a phosphate ester, an oxyalkylated compound, a dialkyl sulfosuccinate, an organic sulfonic acid, or a combination thereof.

6. The inhibitor composition of claim 1, wherein the corrosion inhibitor comprises a film forming corrosion inhibitor selected from an amine-fatty acid condensate, a quaternary ammonium compound, a carboxyl alkene-alkanoic acid compound, or a combination thereof.

7. The inhibitor composition of claim 6, wherein the film forming corrosion inhibitor is present in the inhibitor composition in a concentration from about 1 wt. % to about 60 wt. %, based on the total amount of the polar solvent, the corrosion inhibitor, the scale inhibitor, and the stabilizing corrosion inhibitor, and the stabilizing agent.

8. (canceled)

9. The inhibitor composition of claim 1, wherein the stabilizing corrosion inhibitor comprises an aromatic amine, an alkylamine, a cyclic amine, an alkyl hydroxyl amine, or a combination thereof.

10. The inhibitor composition of claim 9, wherein the stabilizing corrosion inhibitor comprises morpholine, triethanolamin, diethylhydroxylamine, or a combination thereof.

11. (canceled)

12. The inhibitor composition of claim 9, wherein the stabilizing corrosion inhibitor is present in the inhibitor composition in a concentration from about 0.1 wt. % to about 15 wt. %, based on the total amount of the polar solvent, the corrosion inhibitor, the scale inhibitor, the stabilizing corrosion inhibitor, and the stabilizing agent.

13. (canceled)

14. The inhibitor composition of claim 1, wherein the stabilizing agent is present in the inhibitor composition in a concentration from about 0.1 wt. % to about 15 wt. %, based on the total amount of the polar solvent, the corrosion inhibitor, the scale inhibitor, the stabilizing corrosion inhibitor, and the stabilizing agent.

15. (canceled)

16. The inhibitor composition of any one of claims 1 to 15, wherein the scale inhibitor is present in the inhibitor composition in a concentration from about 1 wt. % to about 60 wt. %, based on the total amount of the polar solvent, the corrosion inhibitor, the scale inhibitor, the stabilizing corrosion inhibitor, and the stabilizing agent.

17.-19. (canceled)

20. The inhibitor composition of claim 1, wherein the polar solvent is present in the inhibitor composition at a concentration of from about 40 wt. % to about 70 wt. %, based on the total amount of the polar solvent, the corrosion inhibitor, the scale inhibitor, the stabilizing corrosion inhibitor, and the stabilizing agent.

21. The inhibitor compositions of claim 20, wherein the polar solvent comprises ethylene glycol, propylene glycol, ethylene glycol monobutyl ether, methanol, ethanol, propanol, isopropanol, water, or a combination thereof.

22. (canceled)

23. The inhibitor composition of claim 21, wherein the polar solvent comprises methanol and the methanol is present in the inhibitor composition at a concentration of from about 8 wt. % to about 14 wt. %, based on the total amount of the polar solvent, the corrosion inhibitor, the scale inhibitor, the stabilizing corrosion inhibitor, and the stabilizing agent.

24. (canceled)

25. The inhibitor composition of claim 1, wherein the polar solvent comprises water and the water is present in the inhibitor composition at a concentration of from about 9 wt. % to about 32 wt. %, based on the total amount of the polar solvent, the corrosion inhibitor, the scale inhibitor, the stabilizing corrosion inhibitor, and the stabilizing agent.

26.-45. (canceled)

46. The inhibitor composition of claim 1, wherein the inhibitor composition has a viscosity from about 3 cP to about 260 cP when measured at 4° C. and pressure up to 30,000 psi.

47. The inhibitor composition of claim 1, wherein the inhibitor composition has a viscosity that is substantially similar over a period of from about 16 hours to about 24 hours at a pressure of about 10,000 psi and a temperature of about 4° C.

48. The inhibitor composition of claim 1, wherein the composition is stable as defined by no precipitation of any components, no phase separation of the composition, and no particle formation while the composition remains flowable at a pressure of 100 mbar or less.

49. A method of inhibiting corrosion and scale deposition comprising contacting the inhibitor composition of claim 1 with a hydrocarbon fluid in a subterranean hydrocarbon-containing reservoir.

50.-52. (canceled)
